(19) United States
(12) Patent Application Publication
(10) Pub. No.: US 2010/0273699 A1
(43) Pub. Date: Oct. 28, 2010

(54) USE OF HOMOPOLYMERS OF MALEIC ACID AND ITS SALTS AS SCALE-INHIBITING AGENTS AND ANTI-STICK AGENTS

(75) Inventors: Yves KENSICHER, Theize (FR); Jean-Marc Suau, Lucenay (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: COATEX S.A.S., Genay (FR)

(21) Appl. No.: 12/768,029

(22) Filed: Apr. 27, 2010

Related U.S. Application Data
(60) Provisional application No. 61/175,189, filed on May 4, 2009.

(30) Foreign Application Priority Data
Apr. 27, 2009 (FR) 09-52720

(51) Int. Cl. C02F 5/10; C11D 3/37

(52) U.S. Cl. 510/231; 252/181

(57) ABSTRACT

The invention consists of the use, as scale-prevention and sticking-prevention agents, of homopolymers derived from a maleic acid polymerization, in the presence of a catalytic system using oxygenated water and sodium hypophosphite, in which the molar ratio of sodium hypophosphite/maleic acid is between 0.2 and 1, and preferentially between 0.35 and 0.6.

Scale deposit phenomena refer to the action of mineral salts contained within water which, subjected to temperature and depending on their concentration within the medium, precipitate in the form of deposits, which are variably hard and may stick to walls. Such deposits are troublesome for the output of industrial processes for more than one reason (worsening the phenomena of biofilms and differential corrosion) but particularly from an energy and heat viewpoint, sometimes leading to the total shutdown of an installation, so that it may be cleaned and so parts damaged by the scaling may be replaced.

The most commonly encountered scales are magnesium and calcium carbonate-based ones. For several years, a certain number of additives have been known whose primary function is to prevent the precipitation of mineral salts, and thereby reduce the formation of scales. There are two distinct families of additives, which are highly represented in the literature: those of phosphonates, and those of water-soluble carboxylic polymers with a low molecular mass by weight (less than 5000 g/mole, as determined by Gel Phase Chromatography or GPC). Within the Application, molecular masses will hereafter be referred to by weight.

Phosphonates act by blocking crystal growth mechanisms, as described in the document “Mechanisms of scale inhibition by phosphonates” (Proceedings, International Water Conference, Engineering Society of Western Pennsylvania (1983), 44th, 26-34). These products are broadly described in the literature, as attested to by documents EP 1 392 610, EP 1 392 609, EP 1 351 889, EP 1 152 986, U.S. Pat. No. 5,772,893, U.S. Pat. No. 5,298,221, and U.S. Pat. No. 5,221,487, though without this list being exhaustive.

Among them, there is a category well known to the person skilled in the art which is based in organophosphonic acids, particularly including HEDP or 1-hydroxy-ethylidene-1,1-diphosphonic acid (C₂H₈O₇P₂). Its effectiveness as a scale-reducing agent has been the subject of several studies. By way of example, there are the documents “Research on the anti-scaling ability of ATMP and HEDP using quantum chemistry method” (Huagong Shikan (2008), 22(2), pp. 1-5), “Study of corrosion inhibitors PBTCA, HEDP and ATMP” (Cailiao Kexue Yu Gongyi (2006), 14(6), pp. 608-611) “Study of the scale inhibition by HEDP in a channel flow cell using a quartz crystal microbalance” (Electrochimica Acta (2001), 46(7), pp. 973-985), and “Behavior of the organic phosphonates HEDP and PBTA as corrosion inhibitors of carbon steel in aqueous media” (Revista Iberoamericana de Corrosion y Proteccion (1990), 21(5), pp. 187-91).

However, phosphonates have two major disadvantages. The first one is environmental, because phosphorus is responsible for the eutrophication of lake and river waters, meaning their “suffocation”: this is due to an exaggerated increase in nutritive substances, which increase the production of algae and aquatic plants, which consume surplus oxygen. The second one is economic, as phosphorus is currently a limited natural resource: its market price is very dependent on seasonal demands for certain byproducts such as phosphates in the field of fertilizers. It is therefore important to limit the dose of phosphorus used as much as possible.

The second family of anti-scale agents well known to the person skilled in the art is that of carboxylic polymers with a low molecular weight, generally less than 5000 g/mol, as determined by GPC. The most widespread are acrylic acid-based and maleic acid-based homopolymers and copolymers. They are obtained by polymerizing monomers in water or an appropriate organic solvent, in the presence of a source of free radicals. There are a large number of corresponding synthesis methods.

For example, there are the documents EP 0 058 073, EP 0 108 909, EP 0 441 022, EP 0 491 301, EP 0 561 722, EP 0 569 731, EP 0 818 423, U.S. Pat. No. 5,175,361, U.S. Pat. No. 5,244,988, U.S. Pat. No. 5,360,570. These documents differ in choosing between maleic and acrylic assets for the base, between a homopolymer and a copolymer (and between the various possible co-monomers), between the synthesis conditions, such as the reaction medium, the source of free radicals, the temperature, etc.

However, whether they are organophosphonic assets or carboxylic polymers with low molecular weight, these products are not currently totally satisfactory. This is because, besides their ability to prevent the formation of scale, their ability to prevent them from sticking to walls is also sought by the person skilled in the art. The first of these properties is measured by the mass of precipitate formed in the presence of the tested polymer, within water with a particular salt composition; the second is evaluated by means of the mass of precipitate which then sticks onto the walls.

Continuing its research into discovering a polymer that offers these properties optimally, the Applicant has demonstrated that the polymers of the prior art were not satisfactory: although they were presented as effective scale-prevention agents in the aforementioned documents, they were not as effective in their anti-sticking property.

Additionally, the Applicant has been able to identify among a large number of polymers already described in the literature a class which is entirely unique in resolving this problem: that of homopolymers of maleic acid obtained by a particular method implementing, as a catalyst, a system based in oxygenated water and sodium hypophosphite, which will be explained later.

In this case, these polymers' precipitation-inhibiting power appears to be higher than that of the homopolymers and copolymers of acrylic acid and maleic acid obtained with other catalytic systems. It is even shown that, in one particular variant of the invention, a scale-prevention power on the same level of magnitude as that of HEDP is achieved, but the sticking-prevention power is remarkably improved over that of HEDP. In other words, the aforementioned variant makes it possible to achieve a compromise between scale-prevention and sticking-prevention that has never before been equaled.

Additionally, the present invention consists of the use, as a scale-prevention and sticking-prevention agent, of homopolymers derived from the polymerization of maleic acid, in the presence of a catalytic system using oxygenated water and sodium hypophosphite, with the molar ratio of sodium hypophosphite to maleic acid being between 0.2 and 1, and preferentially between 0.35-0.6.

Such a method is partially disclosed in the document EP 0 819 704 B1, but with a molar ratio between a compound containing phosphorus and a compound which is the monomer to be polymerized falling within 0.005 and 0.49: this ratio is therefore different from that of the invention.

Furthermore, the two inventions do not “overlap”: such an overlap would assume that both inventions intend to handle the same functions for the products in question, without examining whether these products have areas of overlap in their chemical constitution. But this is not the case: here, the use of certain polymers as agents with a dual scale-prevention and sticking-prevention function is claimed, which is not disclosed in the document EP 0 819 704 B 1.

Additionally, nothing in the document EP 0 819 704 B1 suggests focusing on homopolymers of maleic acid, rather than copolymers of that acid, or on homopolymers or copolymers of acrylic acid, which are all claimed and exemplified in this document. Finally, there was no encouragement in that document or elsewhere to select the preferential range of 0.35-0.6 for the molar ratio of sodium hypophospite/maleic acid, in order to obtain the best compromise between scale-prevention and the anti-stick action.

It is important to emphasize that such a result is obtained for a proportion of phosphorus by mass that is much less than in HEDP. Although the phosphorus accounts for 30% of the mass of the HEDP, it represents no more than 14% of the mass of the inventive polymers (in which the molar ratio of sodium hypophosphite/maleic acid=1). This mass proportion is remarkably reduced, and is between 7.1% and 10.4% for the preferential variant of the invention.

Additionally, a first object of the invention resides in the use, as an agent having a dual scale-prevention and sticking-prevention function, of homopolymers characterized in that they are derived from a method of polymerizing maleic acid using as a catalytic system oxygenated water and sodium hypophosphite, in which the molar ratio of sodium hypophosphite/maleic acid is between 0.2 and 1, and preferentially between 0.35 and 0.6.

This use of homopolymers derived from a method of polymerizing maleic acid is further characterized in that said method is conducted in the absence of any agent for breaking the oxygenated water down into free radicals and any other generator of free radicals, as well as the absence of any peroxysalts or other transfer agents.

In a first variant, this use of homopolymers derived from a method of polymerizing maleic acid, is further characterized in that within said method, the entire necessary quantity of sodium hypophosphite is added throughout the polymerization reaction into the starter of the reactor, which contains only water.

In a second variant, this use of homopolymers derived from a method of polymerizing maleic anhydride is further characterized in that within said method, all or some of the necessary quantity of sodium hypophosphite is added before beginning the polymerization, as a load in the starter of the reactor, potentially in the presence of all or some of the maleic acid, either in an acidic state or potentially partially or fully neutralized using a base solution, and in that the reaction of obtaining homopolymers takes place without adding metals and/or metallic salts that would initiate the breakdown of the oxygenated water.

This use is further characterized in that said homopolymers have a molecular weight, as measured by Gas Phase Chromatography (GPC), of between 400 g/mole and 2000 g/mole, preferentially between 400 and 900 g/mole.

This use of homopolymers of maleic acid is further characterized in that it is carried out within aqueous formulations chosen from among detergent compositions and preferentially dishwasher detergents, and compositions for water treatment.

The following examples will make it possible to better understand the invention, though without limiting its scope.

### EXAMPLES

### Example 1

This example illustrates the use of various polymers for cleaning performance, whose scale-prevention power and anti-sticking power with respect to the precipitated scales were measured, in a detergent application.

The polymers are tested according to a procedure defined by the Applicant and based on the document published in November 1999 by the German detergent manufacturers' association (IKW—Industriverband Körperpflege and Waschmittel e.V) entitled “Methods for ascertaining the cleaning performance of dishwasher detergents”. Page 1 of the document lists the average detergent compositions that may be used for dishwashing.

### The Following Detergent Composition is Chosen:

| | |
|---|---|
| Sodium metasilicate | 48.4 g. |
| Sodium carbonate | 48.4 g. |
| Polymer to be tested | 3.2 g. |

Rather than using natural water, which is subject to variations from day to day, the Applicant is using a synthetic water whose hardness is increased by soluble calcium and magnesium salts and whose alkalinity is increased by sodium hydrogenocarbonate.

The solutions used have the following composition:

| | |
|---|---|
| Solution of calcium and magnesium salts: | |
| Dihydrated calcium chloride | 6.62 g/L. |
| Hexahydrated magnesium chloride | 3.05 g/L. |
| Sodium hydrogenocarbonate solution: | |
| Sodium hydrogenocarbonate | 0.6 g/L. |

Detergent mixture solution containing 12.5% of the aforementioned mixture. The tests are prepared by weighing out, in glass flasks that have first been carefully cleaned and dried:

| | |
|---|---|
| Distilled water | 425 g. |
| Solution of calcium and magnesium salts | 25 g. |
| Solution of detergent mixture | 25 g. |
| Sodium hydrogenocarbonate solution | 25 g. |

The carefully evened-out flasks are sealed shut and placed in a bath of water agitated at 100 cycles per minute and heated to 80° C. After two hours of testing, the flasks are removed from the bath and allowed to cool to room temperature.

A sample of the water is then taken, and is passed through a 0.45 micrometer filter in order to eliminate the precipitated salts. A dosage of the hardness of this filtered sample, with EDTA complexometric titration, makes it possible to quantify the mass of alkaline-earth salts remaining in the solution and thereby to obtain the mass of precipitates formed during the test.

The flasks are then emptied and carefully rinsed with distilled water, taking caution to not mechanically eliminate the scales sticking onto the walls. Each flask is then cleaned out with a 2% solution of nitric acid, with the solution resulting from the cleaning being carefully collected and the hardness of the solution measured using EDTA complexometric titration dosing. This operation makes it possible to determine the mass of the stuck scales which formed during the test.

The two results obtained are used to quantify:
the tested polymers' precipitation-inhibiting power, expressed as a mass of the scales formed,
the tested polymers' sticking-prevention power, expressed as a mass of the scales stuck to the walls.

### Test #1

This test corresponds to the reference, i.e. a test with no polymer.

### Test #2

This test illustrates the field outside of the invention, and implements a copolymer of acrylic acid and ethyl acrylate, obtained with a catalytic system different from that of the invention.

In a 2 litre glass reactor equipped with agitation, a thermometer, and a cooling system, a load called the starter is prepared at room temperature which is made up of 0.015 g of iron sulphate and 176 g of water.

Over 2 hours, the following is added using pumps to this starter heated to 73° C.:
in a first beaker, a mixture of 388 g of acrylic acid, 35 g of ethyl acrylate, and 10 g of water,
in a second beaker 3.43 g of sodium persulphate dissolved in 36 g of water,
in a third beaker 179 g of a 40% solution of sodium bisulphite.

The product is then cooked for 1 hour at 70° C., then neutralized with sodium hydroxide to pH=7.

### Test #3

This test illustrates a domain outside the invention and uses a homopolymer of acrylic acids, obtained with a catalytic system different from that of the invention.

This polymer is obtained by so-called Fenton synthesis, using, by way of processes well known to the person skilled in the art, acrylic acid, hydrogen peroxide, iron salt, and solvents.

In a 0.5 litre glass reactor equipped with agitation, a thermometer, and a cooling system, a load called the starter is prepared at room temperature which is made up of 0.27 g of iron sulphate, 112 g of isopropyl alcohol and 0.5 g of amine hydroxyl sulphate.

Over 2 hours, the following is added using pumps to this starter heated to 81° C.:
in a first beaker, 244 g of acrylic acid,
in a second beaker 9 g of amine hydroxyl sulphate dissolved in 67 g of water,
in a third beaker, 39 g of a solution with 130 volume of oxygenated water.

The product is then cooked 1 hour longer at 80° C.

The isopropanol is distilled and replaced during distillation by water, then the polymer is neutralized with 50% sodium hydroxide until it reaches pH 7 for a concentration of 48%. Its molecular mass by weight is 1900 g/mole.

### Test #4

This test illustrates a field outside the invention and uses a homopolymer of acrylic acid, obtained with a catalytic system different from that of the invention and the one used in test #3.

In a 2 litre glass reactor equipped with agitation, a thermometer, and a cooling system, a load called the starter is prepared at room temperature, which is made up of 0.11 g of iron sulphate, 0.015 g of copper sulphate, and 214 g of water.

Over 2 hours, the following is added using pumps to this starter heated to 95° C.:
in a first beaker, 303 g of acrylic acid,
in a second beaker, 26 g of sodium hypophosphite dissolved in 100 g of water,
in a third beaker, 19 g of oxygenated water at 130 volumes with 35 g of water,

The product is then cooked for 1 hour at 95° C., then neutralized with sodium hydroxide to pH=7.

### Test #5

This test illustrates a field outside the invention and uses a homopolymer of acrylic acid, obtained with a catalytic system different from that of the invention and the ones used in tests #3 and #4.

In a 1 litre glass reactor equipped with agitation, a thermometer, and a cooling system, a load called the starter is prepared at room temperature which is made up of 0.011 g of iron sulphate and 124 g of water.

Over 2 hours, the following is added using pumps to this starter heated to 80° C.:
in a first beaker, a mixture of 270 g of acrylic acid,
in a second beaker, 3.3 g of sodium persulphate dissolved in 60 g of water,
in a third beaker, 114 g of sodium bisulphite in a 40% solution.

The product is then cooked for 1 hour at 80° C., then neutralized with sodium hydroxide to pH=7.

### Test #6

This test illustrates a field outside the invention and uses a homopolymer of acrylic acid, obtained with a catalytic system according to the invention and under the conditions of the invention.

In a 2 litre glass reactor equipped with agitation, a thermometer, and a cooling system, a load called a starter is prepared at room temperature which is made up of 144 g of acrylic acid, 144 g of sodium hydroxide in a 50% solution, 82 g of sodium hypophosphite and 130 g of water. While the starter's temperature is being increased to 90° C., a load containing 20 g of oxygenated water at 130 volumes and 100 g of water is prepared.

After 2 hours of adding the load into the reactor heated to 93° C., a polymerizate in a cloudy, colourless solution is obtained.

The product obtained is a cloudy, colourless product whose molecular weight is equal to 1035 g/mole.

The hypophosphite/acrylic acid molar ratio is 0.386.

### Test #7

This test illustrates a field outside the invention and uses a homopolymer of maleic anhydride, obtained with a catalytic system different from the invention.

This polymer is according to the method disclosed in patent GB 1 411 1063

### Test #8

This test illustrates a field outside the invention and uses HEDP.

### Test #9

This test illustrates the invention.

In a 2 litre glass reactor equipped with agitation, a thermometer, and a cooling system, a load called a starter is prepared at room temperature and is made up of 98 g of maleic anhydride, 144 g of sodium hydroxide in a 50% solution, 81.6 g of sodium hypophosphite and 106 g of water. The sodium hypophosphite/maleic acid molar ratio is thereby equal to 0.77.

While the starter's temperature is being increased to boiling point, a load containing 20 g of oxygenated water at 130 volumes and 100 g of water is prepared.

After 2 hours of adding the load into the reactor heated to boiling, a polymerizate in a cloudy, colourless solution is obtained.

The product obtained is a cloudy, colourless product whose molecular mass by weight is equal to 560 g/mole.

### Test #10

This test illustrates the invention.

In a 2 litre glass reactor equipped with agitation, a thermometer, and a cooling system, a load called a starter is prepared at room temperature and is made up of 196 g of maleic anhydride, 288 g of sodium hydroxide in a 50% solution, 60 g of sodium hypophosphite and 100 g of water. The sodium hypophosphite/maleic acid molar ratio is thereby equal to 0.28.

While the starter's temperature is being increased to boiling point, a load containing 20 g of oxygenated water at 130 volumes and 100 g of water is prepared.

After 2 hours of adding the load into the reactor heated to boiling, a polymerizate in a cloudy, colourless solution is obtained.

The product obtained is a cloudy, colourless product whose molecular mass by weight is equal to 680 g/mole.

### Test #11

This test illustrates the invention.

In a 2 litre glass reactor equipped with agitation, a thermometer, and a cooling system, a load called a starter is prepared at room temperature, which is made up of 110 g of maleic anhydride, 144 g of sodium hydroxide in a 50% solution, 106 g of sodium hypophosphite and 106 g of water. The sodium hypophosphite/maleic acid molar ratio is thereby equal to 0.95.

While the starter's temperature is being increased to boiling point, a load containing 20 g of oxygenated water at 130 volumes and 100 g of water is prepared.

After 2 hours of adding the load into the reactor heated to boiling, a polymerizate in a cloudy, colourless solution is obtained.

The product obtained is a cloudy, colourless product whose molecular mass by weight is equal to 445 g/mole.

### Test #12

This test illustrates the invention.

In a 2 litre glass reactor equipped with agitation, a thermometer, and a cooling system, a load called a starter is prepared at room temperature and is made up of 98 g of maleic anhydride, 144 g of sodium hydroxide in a 50% solution, 81.6 g of sodium hypophosphite and 106 g of water, plus 0.015 g of copper sulphate (CuSO₄*5H₂0) and 0.107 g of iron sulphate (FeSO₄*7H₂O). The sodium hypophosphite/maleic acid molar ratio is thereby equal to 0.77.

While the starter's temperature is being increased to boiling point, a load containing 20 g of oxygenated water at 130 volumes and 100 g of water is prepared.

After 2 hours of adding the load into the reactor heated to boiling, a polymerizate in a cloudy, colourless solution is obtained.

The product obtained is a cloudy, colourless product whose molecular mass by weight is equal to 465 g/mole.

### Test #13

This test illustrates the invention.

In a 2 litre glass reactor equipped with agitation, a thermometer, and a cooling system, a load called a starter is prepared at room temperature and is made up of 196 g of maleic anhydride, 288 g of sodium hydroxide in a 50% solution, 126 g of sodium hypophosphite and 130 g of water. The sodium hypophosphite/maleic acid molar ratio is thereby equal to 0.59.

While the starter's temperature is being increased to boiling point, a load containing 20 g of oxygenated water at 130 volumes and 100 g of water is prepared.

After 2 hours of adding the load into the reactor heated to boiling, a polymerizate in a cloudy, colourless solution is obtained.

The product obtained is a cloudy, colourless product whose molecular mass by weight is equal to 610 g/mole.

### Test no. 14

This test illustrates the invention.

In a 2 litre glass reactor equipped with agitation, a thermometer, and a cooling system, a load called a starter is prepared at room temperature and is made up of 196 g of maleic anhydride, 288 g of sodium hydroxide in a 50% solution, 106 g of sodium hypophosphite and 130 g of water. The sodium hypophosphite/maleic acid molar ratio is thereby equal to 0.50.

While the starter's temperature is being increased to boiling point, a load containing 20 g of oxygenated water at 130 volumes and 100 g of water is prepared.

After 2 hours of adding the load into the reactor heated to boiling, a polymerizate in a cloudy, colourless solution is obtained.

The product obtained is a cloudy, colourless product whose molecular mass by weight is equal to 640 g/mole.

### Test #15

This test illustrates the invention.

In a 2 litre glass reactor equipped with agitation, a thermometer, and a cooling system, a load called a starter is prepared at room temperature and is made up of 200 g of maleic anhydride, 186.3 g of sodium hydroxide in a 50% solution, 82.5 g of sodium hypophosphite and 328.7 g of water. The sodium hypophosphite/maleic acid molar ratio is thereby equal to 0.38.

While the starter's temperature is being increased to boiling, a load containing 29.2 g of oxygenated water at 130 volumes and 42.8 g of water is prepared.

After 2 hours of adding this load to the reactor heated to boiling and rinsing the pump, a polymerization in a cloudy, colourless solution is obtained.

The product obtained is a cloudy, colourless product whose molecular mass by weight is equal to 715 g/mole.

For each of the preceding tests, the scale-prevention effectiveness is first examined. In table 1, these tests have been ranked in decreasing order of scale-prevention effectiveness, meaning in decreasing order of the mass of scales formed.

TABLE 1

| | | | Catalyst | | |
|---|---|---|---|---|---|
| | Outside | | Invention/ | | |
| | Invention | | Outside | Molar | Mass of scales |
| Test no. | Invention | nature | Invention | ratio | (mg) |
| 8 | OI | HEDP | — | — | 111 |
| 14 | IN | homo M | IN | 0.5 | 114 |
| 10 | IN | homo M | IN | 0.28 | 114 |
| 11 | IN | homo M | IN | 0.95 | 114 |
| 15 | IN | homo M | IN | 0.38 | 116 |
| 13 | IN | homo M | IN | 0.59 | 117 |
| 12 | IN | homo M | IN | 0.77 | 117 |
| 9 | IN | homo M | IN | 0.77 | 118 |
| 6 | OI | homo AA | IN | — | 120 |
| 7 | OI | homo M | OI | — | 135 |
| 5 | OI | homo AA | OI | — | 132 |
| 4 | OI | homo AA | OI | — | 132 |
| 3 | OI | homo AA | OI | — | 132 |
| 2 | OI | copo AA/EA | OI | — | 134 |
| 1 | OI | — | — | — | 146 |

homo M means: homopolymer of maleic acid
homo AA means: homopolymer of acrylic acid
copo AA/EA means: copolymer of acrylic acid and ethyl acrylate
molar ratio means: molar ratio between the sodium hypophosphite and maleic acid

There are two distinct groups:
group 1 of the homopolymers of the invention, which lead to high scale-prevention effectiveness: the mass of scales is less than 120 mg;
group 2 of polymers of acrylic acid and maleic acid of the prior art, which lead to a moderate scale-prevention action: the mass of scales formed is greater than 120 mg.

It is therefore the dual choice of homopolymers of maleic anhydride and the particular catalytic system of the invention in a very precise ration which leads to such results.

It should particularly be noted that:
a homopolymer of maleic acid created with a different catalytic system is less effective (test #7);
a homopolymer of acrylic acid made with a catalytic system and ratio identical to those of the invention is also less effective (test #6).

HEDP remains the most effective product, but cannot satisfy the person skilled in the art, owing to its excessively high phosphorus concentration (which represents 30% of its mass).

Secondly, it was sought to distinguish, among the products in group 2 whose scale-prevention effectiveness was nearly identical, those which were more effective in terms of anti-sticking power. In table 2, the corresponding tests were ranked in decreasing order of sticking-prevention effectiveness, meaning by decreasing mass of scales that adhered to the walls, while indicating the result obtained for HEDP.

TABLE 2

| | | | Catalyst | | |
|---|---|---|---|---|---|
| | Outside | | Invention/ | | Mass of |
| | Invention | | Outside | | scales |
| Test no. | Invention | nature | Invention | Molar ratio | sticking (mg) |
| 15 | IN | homo M | IN | 0.38 | 19 |
| 14 | IN | homo M | IN | 0.50 | 22 |
| 13 | IN | homo M | IN | 0.59 | 25 |
| 8 | OI | HEDP | — | — | 32 |
| 12 | IN | homo M | IN | 0.77 | 41 |
| 11 | IN | homo M | IN | 0.98 | 44 |
| 10 | IN | homo M | IN | 0.28 | 46 |
| 9 | IN | homo M | IN | 0.77 | 49 |

It thereby clearly appears that the tests corresponding to the preferential variant of the invention (0.35-0.6 for the molar ratio between sodium hypophosphite and maleic acid) lead to much better results: not only in relation to the other inventive polymers but also in relation to HEDP.

### Example 2

This example illustrates the use of various polymers for cleaning performance, whose scale-prevention power and anti-sticking power with respect to the precipitated scales were measured, in a water-treatment application.

The polymers are tested using a procedure defined by the Applicant, and which uses natural water having the following characteristics:
calcium-magnesium hardness=420 ppm of calcium carbonate equivalents;
alkalinity=290 ppm of calcium carbonate equivalents.
   2 active ppm of the tested polymers and additives are added to this natural water, which is then stored in hermetically sealed glass flasks and placed in a bath of water agitated to a temperature of 80 degrees for 60 hours. Afterward, the flasks are removed from the bath and allowed to cool to room temperature.

A sample of the water is then taken, and is passed through a 0.45 micrometer filter in order to eliminate the precipitated salts. A dosage of the hardness of this filtered sample, with EDTA complexometric titration, makes it possible to quantify the percentage of alkaline-earth salts remaining in the solution and thereby the percentage of precipitates formed during the test.

The flasks are then emptied and carefully rinsed with distilled water, taking caution to not mechanically eliminate the scales sticking onto the walls. Each flask is then cleaned out with a 2% solution of nitric acid, with the solution resulting from the cleaning being carefully collected and the hardness of the solution measured using EDTA complexometric titration dosing. This operation makes it possible to determine the quantity of sticking scales which formed during the test.

The two results obtained are used to quantify:
the tested polymers' precipitation-inhibiting power, expressed as a mass of the scales formed;
the polymers' sticking-prevention power, based on the mass of the scales stuck to the walls.

In this example, only HEDP was tested for the prior art, as an off-the-shelf reference.

For the invention, only the polymers corresponding to the preferential variant were tested, meaning products which were used in tests #12, 13 and 14 of the preceding example.

The results are given in table 3, with the polymers having the same test numbers as in the previous example.

TABLE 3

| | | | Catalyst | | | Mass of |
|---|---|---|---|---|---|---|
| | Outside | | Invention/ | | Mass of | scales |
| | Invention | | Outside | Molar | scales | sticking |
| Test no. | Invention | Nature | Invention | ratio | (mg) | (mg) |
| 15 | IN | homo M | IN | 0.38 | 3.5 | 2.0 |
| 13 | IN | homo M | IN | 0.59 | 3.5 | 2.1 |
| 14 | IN | homo M | IN | 0.50 | 4.4 | 2.5 |
| 8 | OI | HEDP | — | — | 4.6 | 2.7 |
| white | OI | — | — | — | 50.5 | 31.5 |

These results demonstrate the superiority of the polymers according to the invention, and the benefit of selecting the 0.35-0.6 interval for the molar ratio between sodium hypophosphite and maleic acid.

1- Use, as an agent having a dual scale-prevention and sticking-prevention function, of homopolymers characterized in that they are derived from a method of polymerizing maleic acid using as a catalytic system oxygenated water and sodium hypophosphite, in which the molar ratio of sodium hypophosphite/maleic acid is between 0.2 and 1, and preferentially between 0.35 and 0.6.

2- Use according to claim 1, of homopolymers derived from a method of polymerizing maleic acid, characterized in that said method is conducted in the absence of any agent for breaking the oxygenated water down into free radicals and any other generator of free radicals, as well as the absence of any peroxysalts or other transfer agents.

3- Use according to claim 2, of homopolymers derived from a method of polymerizing maleic acid, characterized in that within said method, the entire necessary quantity of sodium hypophosphite is added throughout the polymerization reaction in the starter of the reactor, which contains only water.

4- Use according to claim 2, of homopolymers derived from a method of polymerizing maleic acid, characterized in that within said method, all or some of the necessary quantity of sodium hypophosphite is added before beginning the polymerization, as a load in the starter of the reactor, potentially in the presence of all or some of the maleic acid, either in an acidic state or potentially partially or fully neutralized using a base solution, and in that the reaction of obtaining homopolymers takes place without adding metals and/or metallic salts that would initiate the breakdown of the oxygenated water.

5- Use according to one of the claims 1 to 4 of homopolymers derived from a method of polymerizing maleic acid, characterized in that said homopolymers have a molecular weight, as measured by Gas Phase Chromatography (GPC), of between 400 g/mole and 2000 g/mole, preferentially between 400 and 900 g/mole.

6- Use according to one of the claims 1 to 5, characterized in that it is carried out within aqueous formulations chosen from among detergent compositions and preferentially dishwasher detergents, and compositions for water treatment.
